(19) United States
(12) Patent Application Publication
(10) Pub. No.: US 2009/0258717 A1
(43) Pub. Date: Oct. 15, 2009

(54) Power Take-Off Shaft with 80 Degree Angular Displacement

(76) Inventor: Damien Higgins, Victoria (AU)

Correspondence Address: Francis Law Group, 1942 Embarcadero, Oakland, CA, 94606, US

(21) Appl. No.: 11/991,205

(22) PCT Filed: Jan. 23, 2007
(86) PCT No.: PCT/AU2007/000058

§ 371 Date: Feb. 27, 2008

(30) Foreign Application Priority Data
Jan. 23, 2006 (AU) 2006900312

(51) Int. Cl. F16C 3/03; B60K 17/28; A01B 61/02

(52) U.S. Cl. 464/182

(57) ABSTRACT

A power take-off shaft having constant velocity joints that provide consistent drive shaft speeds regardless of the operating angle of a respective joint and, hence, provide a user with an improved apparatus for transferring mechanical power from a tractor or like machinery to a trailing implement. The constant velocity joints also provide for increased angular displacement between a tractor and trailing implement than commonly used universal joints, are more robust and substantially maintenance free.

The present invention relates to an improved power take-off shaft and, in particular, to an improved mechanical connection between an articulated vehicle such as a farm tractor and a power take-off driven trailing implement.

### BACKGROUND OF THE INVENTION

The use of the engine power of vehicles not only for driving their propelling wheels, but also for operating various types of implements has long been an established practice. Tractors, harvesters, trucks and other vehicles are examples of such vehicles. Particular reference is made herein to tractors and a trailing implement therefor.

The tractor and trailing vehicle are usually coupled together for relative horizontal turning movement about a pivot centre on the tractor drawbar. A tractor power take-off (PTO) shaft connects to an implement drive shaft on the trailing vehicle for efficiently transferring mechanical power thereto, and further accommodates for turning of the tractor and trailer relative to each other.

An important requirement for the satisfactory operation of the articulated vehicle assembly of the abovementioned character, is the provision of a power transmitting shaft which:
a) permits a reasonable amount of angular displacement for steering; and
b) keeps the implement drive shaft on the trailer running smoothly throughout the range of angular displacement of the tractor and trailer, that is, without causing periodic fluctuations of the angular velocity of the implement drive shaft. This particularly occurs when the power take-off shaft adjusts itself to accommodate the turning of the tractor and trailer about the pivot centre on the drawbar.

In order to achieve this, it has been customary during the past to universally pivot one section of a torque transmitting, telescopic power take-off shaft, and to likewise pivot the other section of the telescopic power take-off shaft on the drive shaft of the trailer mounted implement. The telescoping shaft allows the power take-off system to flex and adjust when the tractor turns or travels over uneven terrain. However, the present inventor has identified a number of problems with the existing use of universal joints in such applications.

Firstly, the range of movement allowed for by such joints is limited, that is, the maximum angular displacement of the tractor relative to the trailer is in the range of some 30-35 degrees. This has been found to be insufficient under some circumstances, for example, when a particular environment requires the tractor to manoeuvre sharp corners, or where terrain is particularly rough.

Secondly, existing PTO systems require constant maintenance, for example, universal joints need to be periodically greased. This can be a time consuming and difficult task, as is replacement of the universal joints, considering that every component of the power take-off system is commonly shielded to ensure safe operation.

There is therefore a need for a power take-off shaft which provides for improved angular displacement of the tractor and trailer, and which is more robust than hitherto known shafts. There is a further need for a shaft which is substantially maintenance free.

It is therefore an object of the present invention to overcome at least some of the aforementioned problems or to provide the public with a useful alternative.

### SUMMARY OF THE INVENTION

Therefore in one form of the invention there is proposed a power take-off shaft for use in transferring mechanical power from a towing vehicle to a trailing implement, said power take-off shaft characterised by:
a main shaft; and
connection means on opposed ends of said main shaft adapted to mechanically couple a towing vehicle drive assembly with a trailing implement drive assembly, said connection means further configured to accommodate multidirectional movement between said towing vehicle and trailing implement.

The present invention therefore provides a means for increasing the range of angular displacement that is possible between the articulated vehicle and trailing implement beyond what is currently available, whilst also permitting rotation of the power take-off shaft so that mechanical power is transmitted to the implement drive shaft at constant angular velocity.

Preferably each of said connection means is in the form of a constant velocity joint capable of multidirection movement about the shaft axis. Constant velocity (CV) joints allow for angular displacement between the articulated vehicle assembly and the trailing implement of up to 80 degrees in any direction. Further, CV joints require little to no maintenance as opposed to universal joints which require periodic greasing.

Advantageously said ball race sections include an outer housing having a chamfered surface adapted to abut with said main shaft when angular displacement between said drive shaft and said main shaft is at a maximum.

Preferably each of said constant velocity joints includes a ball race section for tiltable connection with an end of said main shaft, providing for said multidirectional movement, and a spline section adapted to engage a drive shaft associated with each drive assembly.

Preferably said main shaft includes a main shaft casing that is telescopically extendible and retractable. This allows for fluctuations in the distance between the respective drive assemblies, for example when turning a corner.

In preference opposed ends of the main shaft are exposed and emerge beyond the ends of the telescopic casing, said exposed ends including external grooves adapted to fixedly engage correspondingly shaped internal grooves associated with the constant velocity joint ball race sections.

Preferably the exposed ends of the main shaft and internal components of the associated ball race section are protected by rubber boots capable of extending and retracting when the joint tilts about the shaft end.

Preferably said power take-off shaft further includes a protective, telescopic housing associated with said main shaft casing whereby said housing extends and contracts correspondingly with said main shaft casing.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings:

FIG. 1 illustrates a perspective view of a power take-off shaft in accordance with the present invention;

FIG. 2 illustrates an exploded perspective view of the power take-off shaft of FIG. 1;

FIG. 3a illustrates a telescopic protective housing for the power take-off shaft of FIGS. 1-2 when in the contracted position;

FIG. 3b illustrates the power take-off shaft telescopic housing of FIG. 3 when in the extended position;

FIG. 4 illustrates a perspective view of the power take-off shaft of FIGS. 1-2 together with the telescopic housing of FIGS. 3a-3b mounted thereto; and

FIG. 5 illustrates a side, cross-sectional view of the power take-off shaft and telescopic housing shown in FIG. 4.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

The present invention relates to an improved power take-off (PTO) shaft 10. The PTO shaft incorporates constant velocity (CV) joints 12 and 14 on opposed ends thereof, the first joint 12 adapted to be coupled to a tractor or like machinery (not shown) and the opposed joint 14 adapted to be coupled to a trailing implement (not shown) so that mechanical power is transferred thereto. It is to be understood that the present invention is not to be limited to agricultural machinery only and that any other vehicles which currently use universal joint-shaft mechanisms as a means of transferring mechanical power may be made to incorporate the features of the present invention.

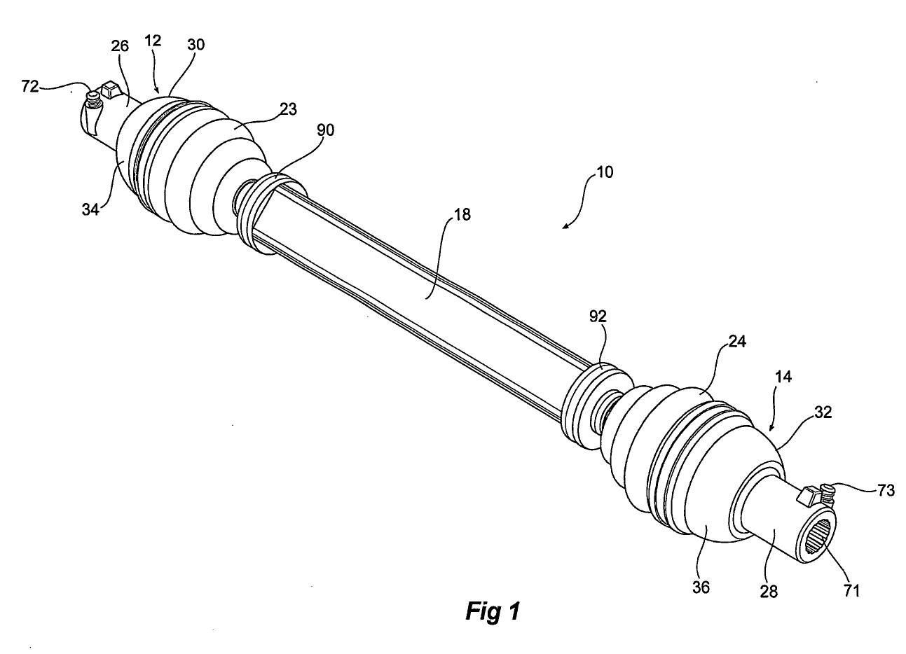

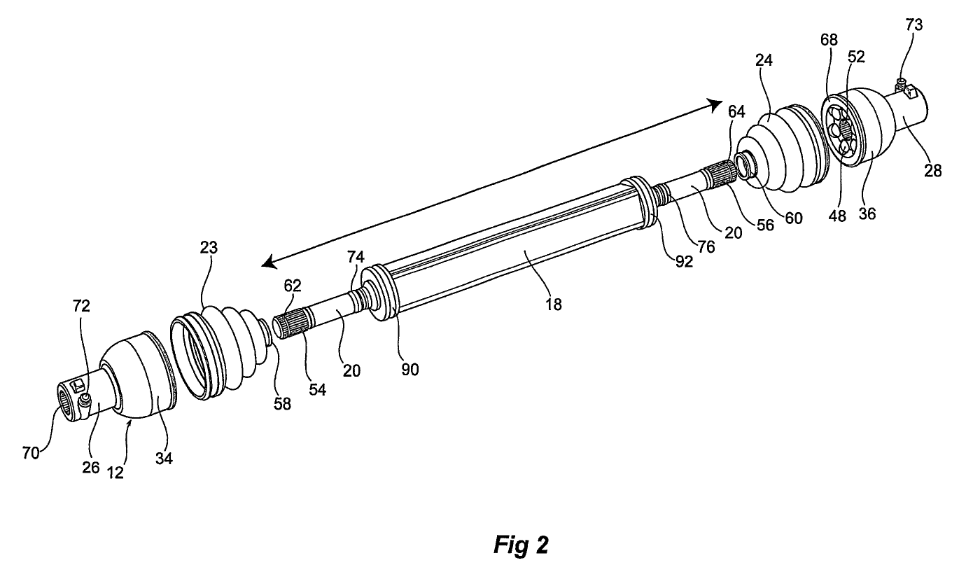

The improved power take-off shaft 10 of the present invention is illustrated in FIGS. 1-2 and comprises a main shaft 16 housed within a telescopic main shaft casing 18 from which emerge opposed ends 20 and 22 of the main shaft 16, two rubber boots 23 and 24 adapted to protect the exposed ends of the shaft 16, and the two CV joints 12 and 14. The CV joints 12 and 14 each comprise a spline section 26 and 28, and a ball race section 30 and 32, respectively.

The ball race sections 30 and 32 include outer housings 34 and 36 respectively, which enclose outer races 38 and 40, inner races 42 and 44, and six spherical balls 46 and 48 therebetween. The inner races 42 and 44 include internal, grooved bores 50 and 52 respectively, adapted to receive and interlock with correspondingly grooved surfaces 54 and 56 associated with each end 20 and 22 of the shaft 16. This enables the ball race housings 34 and 36 to tilt relative to the shaft 16 by well known means. Circlips 58 and 60 are located within small respective grooves 62 and 64 which encircle the respective grooved surfaces 50 and 52 to ensure that the grooved surfaces are maintained within the bores during use.

Each of the ball race housings 34 and 36 are frusto-spherically shaped and include internal chamfered edges 66 and 68 so that when, for example, CV joint 12 is at maximum displacement, the chamfered edge 66 will contact the shaft end 20. Of course, because the housing 34 will be spinning at the same rate as the shaft 16, this contact will not impede rotation of the shaft 16. In preference, the exposed ends 20 and 22 of the main shaft 16 are constructed of hardened metal.

The spline sections 26 and 28 of respective CV joints 12 and 14 are rigid, substantially cylindrical hollow structures and serve to connect each CV joint to either the tractor drive assembly (not shown) or the drive assembly of the trailing implement (not shown). The spline sections include grooved internal bores 70 and 71 adapted to receive a correspondingly grooved drive shaft (not shown) associated with the tractor or trailing implement. The spline sections further include retaining pins 72 and 73 as a secondary connection means. The retaining pins 70 and 71 are biased, typically spring loaded, and adapted to lock in and thereby engage receiving apertures (not shown) associated with the tractor or trailing implement.

The use of CV joints 12 and 14 allow for a wide variety of movement between the tractor and trailing implement relative to the main shaft 16. Where existing power take-off shafts allow for a maximum angular displacement of approximately 30-35 degrees, the shaft 10 of the present invention allows for some 75-80 degree displacement in all directions.

The telescoping nature of the main shaft casing 18 will not be described here in any detail in that it is well known in the art for agricultural power take-off shafts to be telescopic to allow for the displacement of the trailing vehicle/machinery relative to the tractor.

Each rubber boot 23 and 24 is of a bellow-type structure connected at its wider end around the ball race housings 34 and 36, and at its narrower end around flanged portions 74 and 76 associated with each respective shaft end 20 and 22. The flanged portions 74 and 76 are located adjacent opposed ends of the shaft casing 18. The rubber boots 23 and 24 are designed to expand and retract as the CV joints rotate relative to the main shaft 16. As mentioned earlier, the rubber boots 23 and 24 are used to prevent foreign matter from entering the area adjacent the exposed shaft ends 20 and 22 and the inside of the ball race sections 30 and 32.

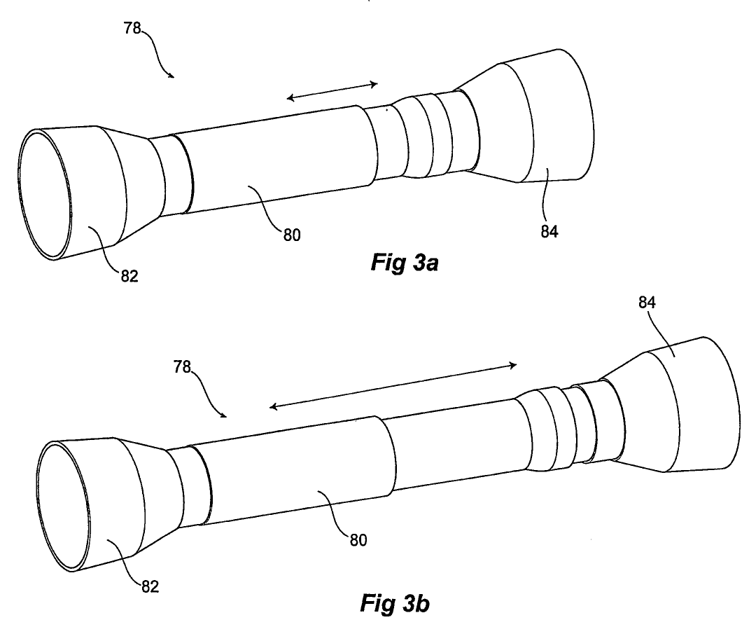

FIGS. 3a and 3b illustrate a telescopic housing 78 for the power take-off shaft 10, firstly in the retracted state, and secondly in the extended state. Although not shown, the housing is adapted to be held in place and secured to the tractor via ropes, or any other suitable supporting means. The housing 78 comprises a cylindrical, telescopic tube 80 having end sections 82 and 84 which splay outwardly, that is, their diameter is greater than the diameter of tube 80, in order to accommodate the CV joints 12 and 14 respectively.

On the inside surface of the telescopic tube 80, adjacent each end section 82 and 84, is a respective rounded lip 86 and 88. The telescopic shaft casing 18 includes annular channels 90 and 92 at opposed ends thereof adapted to engage the rounded lips 86 and 88 respectively, in a way which allows the PTO shaft 10 to rotate freely within the housing 78. The housing 78 itself does not rotate with the shaft 10. In other words, the rounded lips 86 and 88 of the housing 78 merely act as guides for the respective rotating channels 90 and 92, and also as a means to connect the telescopic casing 18 of the shaft 10 with the telescopic housing 78 so that when the casing 18 extends and retracts, for example when the tractor is turning, so will the outer housing 78. It is to be understood that alternate means of attaching the outer housing 78 could be used. The outer housing is preferably constructed of a rigid plastic material.

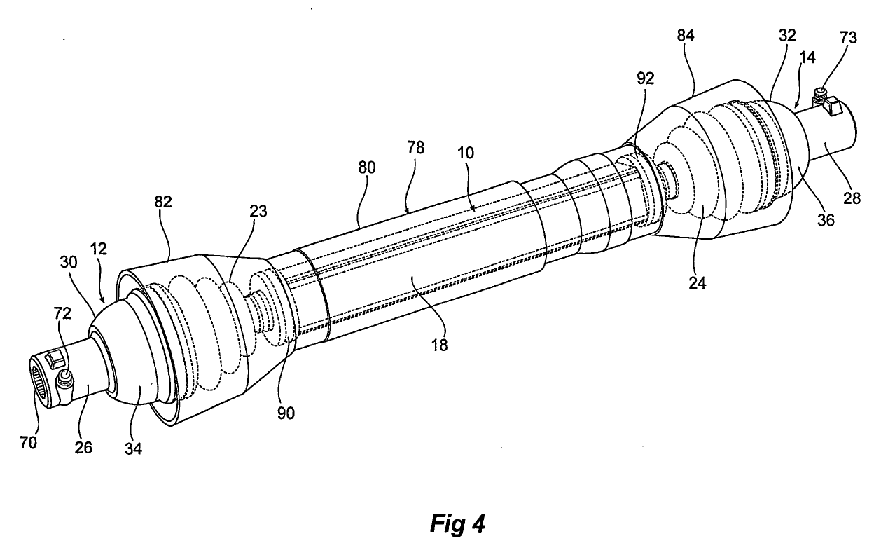

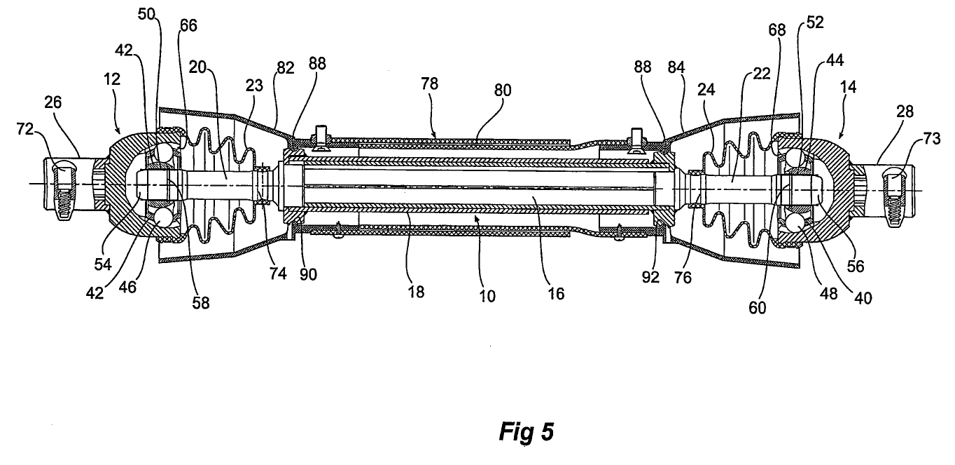

FIGS. 4 and 5 illustrate a fully assembled power take-off shaft 10 including the abovementioned housing 78. Each component of the assembly can be clearly seen in FIG. 5. The power take-off shaft 10 embodied in the present invention is rated at approximately 80 horse power, however, it is to be understood that in order to increase the rating of the shaft 10, larger CV joints may be used.

The power take-off shaft 10 of the present invention therefore provides a user with an improved apparatus for transferring mechanical power from a tractor or like machinery to a trailing implement. The use of constant velocity joints 12 and 14 provides consistent drive shaft speeds regardless of the operating angle of the joint. They also provide for increased angular displacement between the tractor and trailing implement than commonly used universal joints, are more robust, and are substantially maintenance free.

It is to be understood that the present invention may also be used in other applications which currently involve the use of universal joints such as the automotive industry.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. A power take-off shaft for use in transferring mechanical power from a first drive means to a second drive means, said power take-off shaft comprising:
a main shaft body; and
first and second joints disposed at longitudinal ends of the main shaft body and configured to mechanically couple said first and second drive means, wherein at least one of said first and second joints includes a ball race section adapted for engagement with said main shaft body in a configuration that enables three-dimensional angular displacement between a corresponding drive means and said main shaft body.

2. The power take-off shaft of claim 1, wherein said first and second joints include said ball race section that enables three-dimensional angular displacement between the said first and second drive means and said main shaft body.

3. The power take-off shaft of claim 1, wherein said first and second drive means are in the form of drive shafts, and wherein said first and second joints are adapted to be fixedly connected to said first and second drive means.

4. The power take-off shaft of claim 3. wherein said ball race section includes an outer frusto-conical housing having a chamfered edge adapted to abut with said main shaft body when angular displacement between at least one of said first and second drive means and said main shaft body is at a maximum.

5. The power take-off shaft of claim 4. wherein said maximum angular displacement is approximately 80 degrees.

6. The power take-off shaft of claim 3, wherein said first and second joints include a spline section adapted to fixedly engaging said first and second drive means.

7. The power take-off shaft of claim 1, wherein said first drive means comprises a drive shaft associated with a towing vehicle, and said second drive means comprises a drive shaft associated with a trailing implement.

8. The power take-off shaft of claim 1, wherein said main shaft body is telescopically extendable and retractable to accommodate for said angular displacement between said first and second drive means and said main shaft body.

9. The power take-off shaft of claim 1, wherein said power take-off shaft further includes a protective, telescopic housing associated with said main shaft body, said housing being adapted to extend and retract correspondingly with said main shaft body.

10. The power take-off shaft of claim 2, wherein internal components of said ball race sections are protected by rubber boots that are adapted to extend and retract to accommodate for said angular displacement between said first and second drive means and said main shaft body.
